(19) United States
(12) Patent Application Publication
(10) Pub. No.: US 2008/0298397 A1
(43) Pub. Date: Dec. 4, 2008

(54) COMMUNICATION FABRIC BANDWIDTH MANAGEMENT

(75) Inventors: Bruce Kwan, Sunnyvale, CA (US); Bora Akyol, San Jose, CA (US); Puneet Agarwal, Cupertino, CA (US)

Correspondence Address: BRAKE HUGHES BELLERMANN LLP;c/o Intellevate, P.O. Box 52050, Minneapolis, MN, 55402, US

(73) Assignee: BROADCOM CORPORATION, Irvine, CA (US)

(21) Appl. No.: 12/121,588

(22) Filed: May 15, 2008

Related U.S. Application Data
(60) Provisional application No. 60/938,302, filed on May 16, 2007.

(51) Int. Cl. H04J 3/18

(52) U.S. Cl. 370/477

(57) ABSTRACT

Methods and apparatus for communication fabric bandwidth management are disclosed. An example method includes receiving data at a first network entity, where the data being received from a second network entity. The example method further includes, at the first network entity, queuing the received data in a data queue associated with the second network entity. The example method still further includes determining that an amount of queued data in the data queue associated with the second network entity exceeds a first threshold. In response to the first threshold being exceeded, a first control message is communicated from the first network entity to the second network entity. In the example method, in response to the first control message, a data rate at which the second network entity sends data to the first network entity is reduced.

### CROSS REFERENCE TO RELATED APPLICATIONS

The application claims priority under 35 U.S.C. § 119(e) to U.S. Provisional Application 60/938,302, filed on May 16, 2007, entitled “Communication Fabric Bandwidth Management,” which is hereby incorporated by reference.

### TECHNICAL FIELD

This description relates to management of data bandwidth resources for communication fabrics, such as communication fabrics in data networks.

### BACKGROUND

Electronic data in, for example, data networks or data network subsystems, may be communicated over data links. These data links may be collectively referred to a data communication fabric, or communication fabric. The links may be wired links or wireless links. The amount of data that can be communicated over a communication fabric in a given period of time may be referred to as data bandwidth, network bandwidth or simply bandwidth. Because bandwidth is a limited resource, use of that bandwidth is often managed by one or more entities in an associated data network or data network subsystem (collectively “networks”). Such management may have any number of objectives. Two such objects may be efficient use of available bandwidth in the communication fabric and “fair” allocation of the available bandwidth to entities on the network that are competing for use of the bandwidth.

One approach that is used for managing bandwidth, such as, for example, in ring networks, is the use of a token. In a token network, a token (e.g., an electronic file or marker) is passed from network entity to network entity. In such networks, the network entity holding the token is the only entity on the network that has access to the bandwidth of the communication fabric during the time it holds the token. The token is typically held by each entity of the ring network for a specified period of time before being passed to the next entity in the network. Such an approach has a number of drawbacks.

First management of the token may be complicated. For instance, if a network entity holding the token drops of the network, which may occur due to any number of reasons, the token would need to be generated by another entity on the network. During the regeneration of the token, there is typically no data being communicated in the network, thus bandwidth is wasted.

Second, because only a single network entity (the entity holding the token) communicates data at any particular time, the other entities on the network sit “idle” (not communicating data), even though one or more of those network entities could feasibly communicate data in the network without interfering with the data being communicated by the network entity that holds the token. Again, in this situation, bandwidth is wasted.

Third, if there is little data traffic on the network, any network entities that have data to communicate must wait for the token to be passed to them before they can communicate their data. Again, this is an inefficient use of bandwidth and also creates delay in communicating data in the network.

Another approach for communicating data in networks is to communicate data without the use of a token where the network entities collectively manage the bandwidth. In certain networks, such as ring networks, such an approach may result in unfair allocation of bandwidth between the network entities. For instance, in the situation where a particular network entity has a constant stream of data to communicate, that network entity may consume all of the bandwidth over certain links in the communication fabric. If other network entities are waiting to communicate data over those same links, data buffers in the waiting entities may fill up. In such a situation, data may be lost or dropped and, thus, need to be communicated again. This results in both unfair allocation of the bandwidth (due to a single entity monopolizing particular links) as well as inefficient use of bandwidth due to data being lost or dropped and needing to be retransmitted.

### BRIEF DESCRIPTION OF THE DRAWINGS

FIG. 1 is a block diagram of an example network in which communication fabric bandwidth management may be implemented.

FIG. 2 is a block diagram of another example network in which communication fabric bandwidth management may be implemented.

FIG. 3 is a block diagram of an example network entity that may be implemented in the networks of FIGS. 1 and 2.

FIG. 4 is a diagram of an example control message that may be used for communication fabric bandwidth management.

FIG. 5 is a flowchart of an example method for communication fabric bandwidth management.

FIG. 6 is flowchart of another example method for communication fabric bandwidth management.

### DETAILED DESCRIPTION

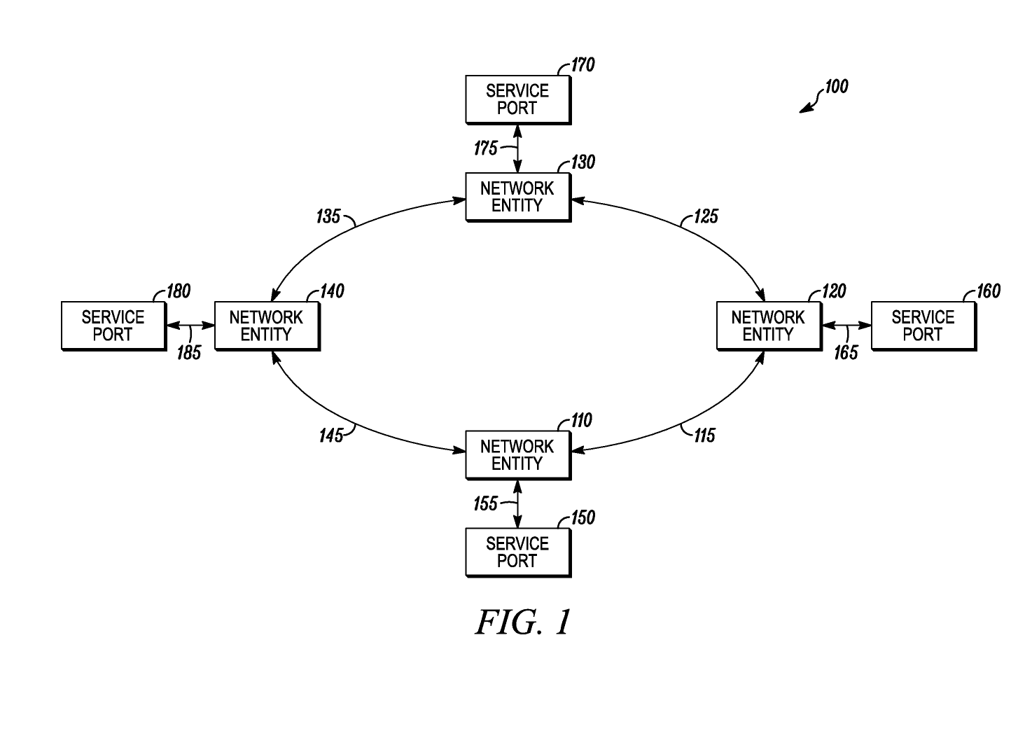

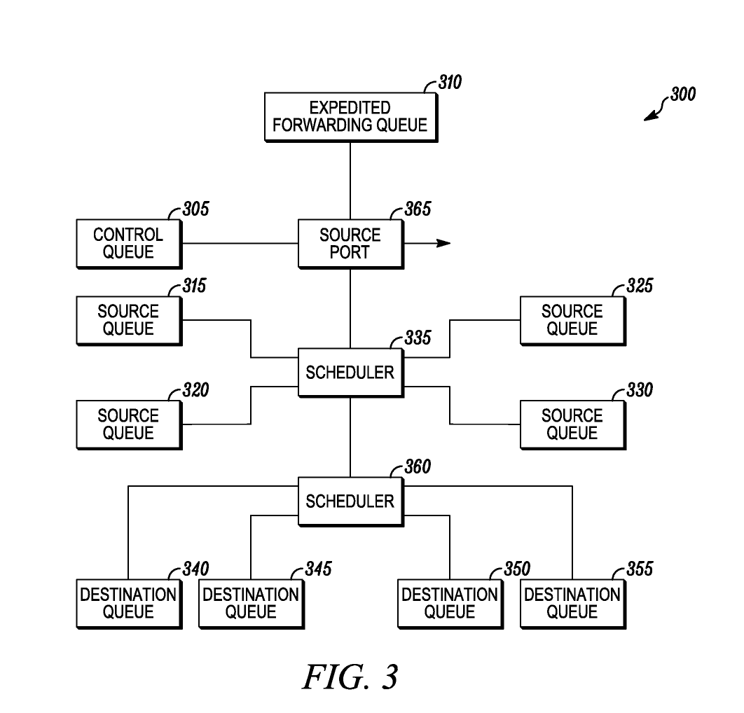

FIG. 1 is a block diagram of an example network 100 in which communication fabric bandwidth management using the techniques described herein may be implemented. The network 100 will be generally described with reference to FIG. 1, while example communication fabric management techniques will be described below with further reference to FIGS. 3-6.

The network 100 includes a ring network. The ring network includes a network entity 110, which is coupled, via a communication link 115, with a network entity 120. The network entity 120 is, in turn, coupled, via a communication link 125, with a network entity 130. Likewise, the network entity 130 is coupled, via a communication link 135, with a network entity 140. The network entity 140 is coupled, via a communication link 145, with the network entity 110, which completes the ring network. Data may be communicated between the network entities 110, 120, 130 and 140 of the ring network via the communication links 115, 125, 135 and 145. For purposes of this disclosure, such data traffic is referred to as transit traffic.

The network 100 further includes a service port 150, which is coupled with the network entity 110 via a communication link 155. Similarly, the network 100 also includes service ports 160, 170 and 180, which are coupled, respectively, with network entities 120, 130 and 140 via respective communication links 165, 175 and 185. The service ports 150, 160, 170 and 180 may receive data from any number of devices that are external to the network 100 and communicate that data onto the ring network via the communication links 155, 165, 175 and 185. For purposes of this disclosure, such data traffic is referred to as add-in traffic.

Other types of data traffic may also be communicated using the network 100. For instance, data traffic may be communicated out of the ring network via one of the service ports 150, 160, 170 and 180. For purposes of this disclosure, such data traffic is referred to as egress traffic. As another example, data traffic may be communicated from the service port 150 to the network entity 110. That data traffic may then be communicated back to the service port 150 without being added to the ring network. For purposes of this disclosure, such data traffic is referred to as local egress traffic, or locally switched traffic. For the network 100, egress traffic and local egress traffic may also be communicated using the network entities 120, 130 and 140.

The network entities 110, 120, 130 and 140 may be implemented using any number of network devices. For instance, the network entities 110, 120, 130 and 140 may be implemented as data switches. Such an arrangement may be used in a packet data network “wiring closet” where data switches are arranged in a stacked (ring) arrangement. In such arrangements, the stacked data switches may be configured to behave as a single data switch to devices that are not part of the wiring closet (e.g., devices external to the network 100). For the network 100, data received at one of the network entities 110, 120, 130, and 140 may be communicated to any of the other ring network entities over the ring network, thus allowing the network 100 to behave as a single entity with respect to such external devices.

As shown in FIG. 1, transit traffic may be communicated between the network entities 110, 120, 130 and 140 in both directions in the ring. Accordingly, for the network 100, transit traffic may be communicated from one side of the ring network (e.g., from the network entity 110) in the ring network such that the shortest path is taken. For instance, each of the network entities 110, 120, 130 and 140 may include a lookup table that represents the arrangement of the ring network. Routing decisions for communicating data may be based on such lookup tables.

Transit traffic may also be communicated in both directions over the communication links 115, 125,135 and 145 at the same time allowing for “spatial reuse” of the communication links 115, 125, 135 and 145. Such an approach may improve the efficiency of use of communication fabric bandwidth for the ring network of the network 100. It is noted that the arrangement shown in FIG. 1 is given by way of example and other arrangements are possible. For instance, the ring network of the network 100 may include additional or fewer network entities and associated communication links.

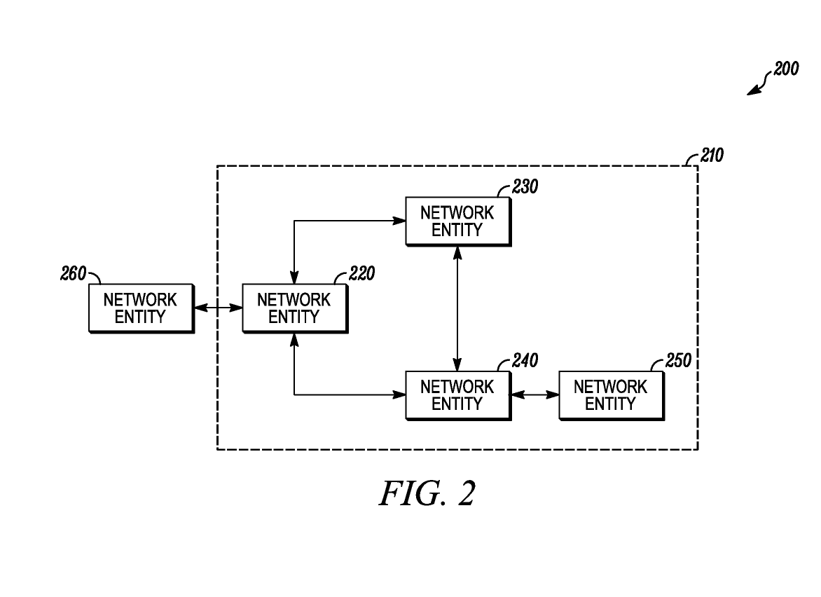

FIG. 2 is a block diagram illustrating another example network 200 in which communication fabric bandwidth management using the techniques described herein may be implemented. In like fashion as with the above discussion of the network 100 of FIG. 1, the network 200 will be generally described with reference to FIG. 2, while example communication fabric management techniques will be described below with further reference to FIGS. 3-6.

The network 200 includes a mesh network 210. The mesh network 210 includes a network entity 220, which is coupled with network entities 230 and 240. The network entity 230 is further coupled with the network entity 240. The network entity 240 is still further coupled with a network entity 250. Data traffic may be communicated between the network entities 220, 230, 240 and 250 of the mesh network 210 using any of the illustrated communication links. For instance, data traffic may be communicated from the network entity 220 to the network entity 250 via the network entity 240. As an alternative, data traffic may be communicated from the network 220 to the network entity 250 via the network entity 230 and the network entity 240. For purposes of this disclosure, data traffic in the mesh network 210 will be referred to as transit traffic. The particular arrangement of the mesh network 210 (and the network 200) is given by way of example and any number of other arrangements is possible.

The network 200 also includes a network entity 260 that is not included in the mesh network 210. The network entity 260 may take any number of forms. For example, the network entity 260 may comprise a network device, such as a router, a data switch or a network access point. Alternatively, the network entity 260 may comprise another data network. In similar fashion as discussed above with respect to the service ports 150, 160, 170 and 180, the network entity 260 may add data traffic to the mesh network 210. For purposes of this disclosure, such data traffic will be referred to as add-in traffic. Of course, other types of data traffic may be communicated in the network 200. For instance, data traffic may be communicated from the mesh network 210 to the network entity 260, via the network entity 230. Such traffic is referred to herein as egress traffic.

FIG. 3 is an example network entity 300 that may be used to implement the network entities illustrated in FIGS. 1 and 2. In certain embodiments, the network entity 300 may also be used to implement the service ports 150, 160, 170 and 180 of the network 100. The network entity 300 includes a control queue 305. The control queue 305 may be used to buffer control messages that are used for communication fabric management in a network, such as the networks 100 and 200 discussed above. In an example embodiment, queuing structures, such as the control queue, may be included at the fabric source port 365. In certain embodiments, control message traffic may be given priority over other types of data traffic. For example, a certain amount of bandwidth of a network's communication fabric may be allocated for communicating control messages that are buffered in the control queue 305.

When a control message is communicated from a first network entity 300 to a second network entity 300, the control message may be communicated from the control queue 305 of the first network entity 300 to a source port 365 of the first network entity 300. The control message may then be communicated from the source port 365 of the first network entity 300 to the second network entity 300, where it is buffered in the control queue 305 of the second network entity 300.

The network entity 300 also includes an expedited forwarding (EF) queue 310. The EF queue 310 may be used to buffer EF traffic in a network. EF traffic may be data traffic that has a higher communication priority than other types of data traffic (e.g., excluding control message traffic, as previously discussed) in a network. For instance, a network may implement a quality of service (QoS) policy that allocates a dedicated amount of bandwidth in a network for communicating EF traffic. The remaining bandwidth (e.g., bandwidth not used by control messages and EF traffic) may be managed using the communication fabric management techniques described herein.

The network entity 300 also includes a plurality of source queues that may be used for buffering transit traffic in a network, such as the networks 100 and 200 described above. The plurality of source queues includes source queues 315, 320, 325 and 330. Data that is queued in the source queues may be communicated from a first network entity 300 to a second network entity 300 using a scheduler 335 and the source port 365. The scheduler 335 may operate in accordance with a work-conserving, fair-scheduling procedure. For instance, the scheduler 335 may implement a weighted-deficit, round-robin scheduling approach. Of course, other scheduling approaches may be used.

The source queues 315, 320, 325 and 330 may each be respectively associated with a network entity of a network. For example, if the network entity 300 is implemented as the network entity 110 of the network 100, the source queue 315 may be associated with the network entity 110, the source queue 320 may be associated with the network entity 120, the source queue 325 may be associated with the network entity 130, and the source queue 330 may be associated with the network entity 140. Likewise, if the network entity 300 is used to implement the network entity 220 in the network 200, the source queue 315 may be associated with the network entity 220, the source queue 320 may be associated with the network entity 230, the source queue 325 may be associated with the network entity 240, and the source queue 330 may be associated with the network entity 250. These example source queue-to-network entity associations for the networks 100 and 200 will be used throughout the remainder of this disclosure.

Using such an approach, data streams originating from a particular network entity may be buffered in the source queue associated with the originating network entity. For instance, if a data stream originating from the network entity 140 (e.g., add-in traffic originating at the source port 180) is communicated to any of the other network entities 110, 120 or 130, that data stream may be buffered/communicated using the source queues 330 in each of the other network entities 110, 120 and 130.

The network entity 300 also includes a plurality of destination queues 340, 345, 350 and 355 that may be used for buffering add-in traffic in a network, such as the networks 100 and 200 described above. The plurality of destination queues includes destination queues 340, 345, 350 and 355.

As with the source queues 315, 320, 325 and 330, the destination queues 340, 345, 350 and 355 may each be respectively associated with a network entity of a network. For example, if the network entity 300 is implemented as the network entity 110 of the network 100, the destination queue 340 may be associated with the network entity 110, the destination queue 345 may be associated with the network entity 120, the destination queue 350 may be associated with the network entity 130, and the destination queue 355 may be associated with the network entity 140. Likewise, if the network entity 300 is used to implement the network entity 220 in the network 200, the destination queue 340 may be associated with the network entity 220, the destination queue 345 may be associated with the network entity 230, the destination queue 350 may be associated with the network entity 240, and the destination queue 355 may be associated with the network entity 250. As with the source queue-to-network entity associations discussed above, these example destination queue-to-network entity associations for the networks 100 and 200 will also be used throughout the remainder of this disclosure.

Using such an arrangement, add-in-traffic may enter the ring network in FIG. 1 in the following fashion. A data stream that is addressed for communication to the network entity 130 may be received at the service port 150 of the network 100. The service port 150 may then communicate the data stream to the network entity 110. The network entity 110 may then examine the data stream, such as packet headers included in the data stream, and determine that the data stream is addressed to the network entity 130. Accordingly, the network entity may buffer the data stream in the destination queue 350, which is associated with the network entity 130. The data stream is then added to the ring network, thus becoming transit traffic. For instance, the network entity 110 may communicate the data stream from the destination queue 350 to the network entity 120 via a scheduler 360, the scheduler 335 and the source port 365. The data stream may be queued (buffered) in the source queue 315 of the network entity 120. As with the scheduler 335, the scheduler 360 may operate in accordance with a work-conserving, fair-scheduling procedure. Further, the scheduler 360 may operate in conjunction with the scheduler 335 to fairly allocate bandwidth between transit traffic in the source queues 315, 320, 325 and 330 and add-in traffic in the destination queues, 340, 345, 350 and 355.

It will be appreciated that “fair” allocation of bandwidth may depend on the particular embodiment. For instance, bandwidth may be allocated substantially equally among any network entities competing for bandwidth. In such an arrangement, if four network entities are competing for bandwidth, each entity may be allocated twenty-five percent of the available bandwidth.

In other embodiments, bandwidth may be allocated on a metered basis. For instance, traffic originating from a particular source (network entity) may be allocated a higher percentage of the bandwidth than other data traffic. Such allocations may be done dynamically based on the amount of data traffic in a network and the types of traffic in the network. Such an approach may improve the efficiency of bandwidth use in a network. For instance, in a large ring network, data traffic may have to travel a large number of hops before it reaches its destination. If there is an equal probability of such traffic being dropped at each hop, the likelihood that such traffic will successfully reach its destination may be unacceptably low. Using a lookup table that represents the arrangement of the network, such as discussed above, the number of hops the data stream will make en route to its destination can be determined, and a higher percentage of a bandwidth may be dynamically allocated for that data stream (e.g., for the source queues used to communicate the data stream), so as to increase the likelihood that the data stream will successfully reach its destination.

Communication fabric bandwidth management, such as modifying data traffic flow in response to data congestion, may be implemented in the networks 100 and 200 using control messages that are communicated between the network entities of those networks. The networks 100 and 200 are, of course, given by way of example, and any number of other network configurations may be used to implement the example fabric bandwidth management techniques discussed herein.

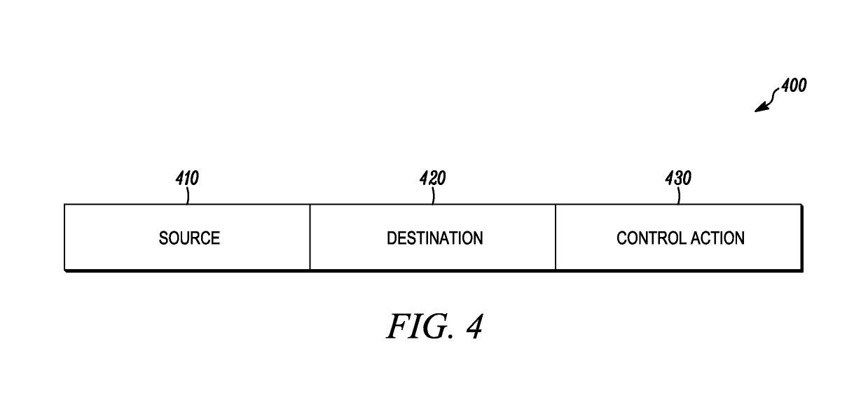

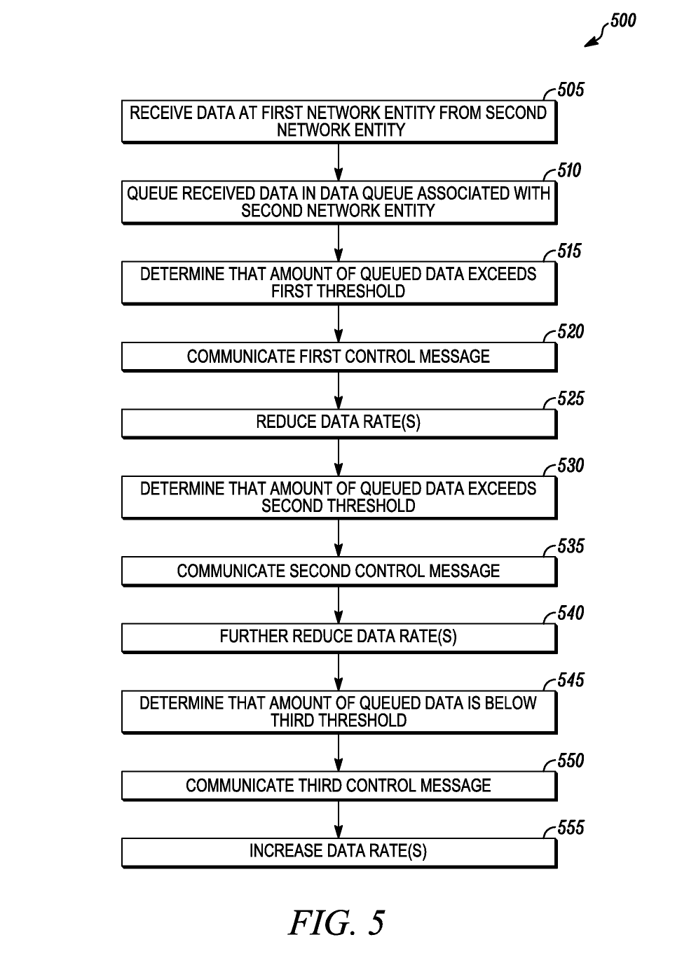

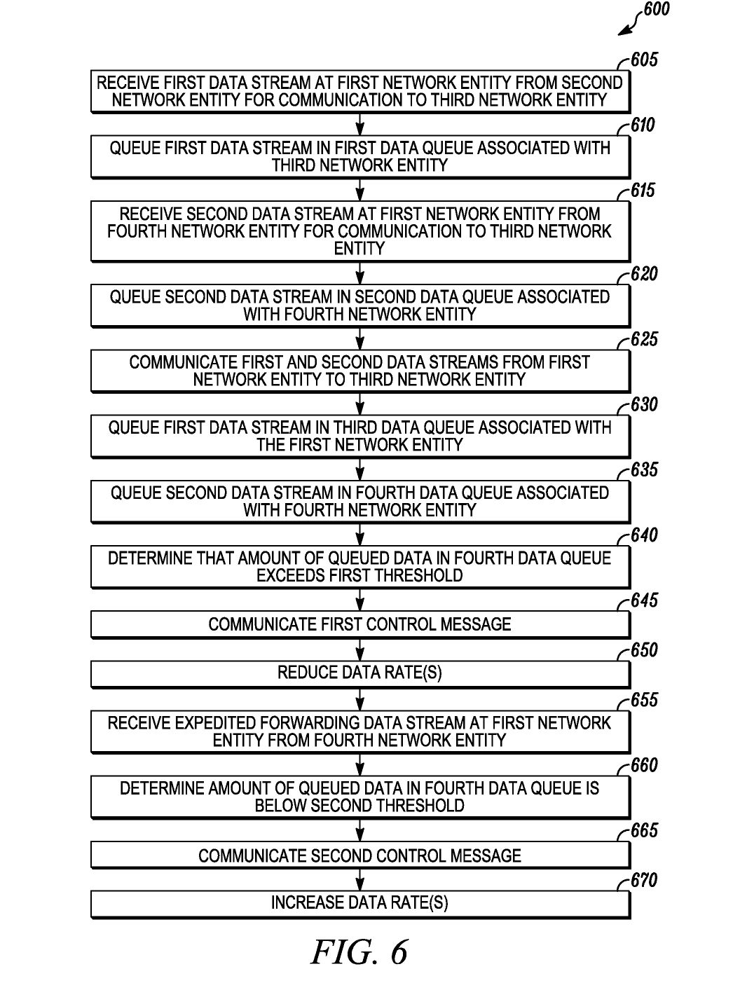

FIG. 4 is a diagram of an example control message 400 that may be used to implement fabric bandwidth management, such as in accordance with the methods illustrated in FIGS. 5 and 6, for example. As an example, a network entity 300, when implemented in the network 100 or 200, may monitor the amount of data that is buffered in each of its source queues 315, 320, 325 and 330 (and/or destination queues 340, 345, 350 and 355). When the amount of data queued in a particular queue reaches a threshold amount, the network entity may communicate a control message 400 in response to a threshold being met or crossed.

The control message 400 includes a source field 410, which may include an identifier of the network entity that is sending data and is associated with the queue that reached a threshold amount of data. The control message 400 may also includes a destination field 420, which may include an identifier of the network entity that is receiving the data and includes the queue that reached a threshold amount of data. The source and destination identifiers may be, for example, network addresses, such as Ethernet or MAC addresses. The control message 400 further includes a control action field 430, which may include an action to be taken in response to the threshold being met or crossed. The control action specified in the control action field 430 may be any number of possible actions and will depend, at least in part, on the specific threshold that was met or crossed.

FIGS. 5 and 6 are flowcharts illustrating example methods 500 and 600, respectively, for communication fabric bandwidth management. These example methods will be described with reference to FIGS. 1-4. For purposes of illustration, the example method 500 of FIG. 5 will be described with reference to the network 200 illustrated in FIG. 2 and the example method 600 of FIG. 6 will be described with reference to the network 100 illustrated in FIG. 1. It will be appreciated, however, that the example methods of FIGS. 5 and 6 may be applied to either network 100 or network 200, as well as any number of other network arrangements. For purposes of this disclosure, in the discussion of the methods 500 and 600, the network entities of the ring network in the network 100 and the mesh network 210 in the network 200 will be described as each being implemented by the network entity 300 and having the queue associations described above with respect to FIG. 3.

The method 500, at block 505, may include the network entity 230 receiving, from the network entity 260, data addressed to the network entity 250. As previously discussed, this data may be add-in traffic to the mesh network 210. Accordingly, the data received at the network entity 220 may be queued in the destination queue 355 of the network entity 220, which is the destination queue associated with the network entity 250. The data may then be communicated to the network entity 250, via the network entity 240, for example. The data may then be queued, at block 510 of the method 500, in the source queue 315 of the network entity 250, which is the source queue associated with the network entity 220.

If there is a significant amount of data traffic being communicated through the network entity 250 in the network 210, the amount of data queued in the source queue 315 of the network entity 240 may increase due, for example, to data traffic congestion. The network entity 250 may monitor the amount of queued data in the source queue 315 (as well as the other source queues 320, 325 and 330), such as by using a processor or other device. If the amount of data in the source queue 315, at block 515, exceeds a first threshold amount the network entity 250, at block 520, may communicate a control message 400 to the network entity 220 to instruct the network entity 230 to take action, so as to proactively respond to such data congestion. The control message 400 may include a source identifier associated with the network entity 220 and a destination identifier associated with the network entity 250.

The control message 400, at block 525, may instruct the network entity 220 to reduce a rate at which it is sending data to the network entity 250. For instance, the control message 400 may include a control action that instructs the network entity 220 to reduce the rate at which it sends data to the network entity 250 by a certain percentage of a nominal data rate, or may instruct the network entity 220 to stop sending data to the network entity 250. The control action may include a time duration. For instance, the network entity 250 may send a control action 430 to the network entity 220 that instructs the network entity 220 to stop sending data to the network entity 250 for a time duration of 100 ms. In such a situation, after the 100 ms time duration has passed, the network entity 220 may resume sending data to the network entity 250.

The control message 400 may be communicated from the network entity 250 to the network entity 220 via the network entity 240. In certain embodiments, the network entity 240 may also reduce a rate at which it sends data to the network entity 250 in response to the control message 400 in order to reduce the amount of data traffic being communicated to the network entity 250, so that any data traffic congestion can be more readily resolved. If the data traffic congestion is not addressed, the source queue 315 in the network entity 250 may completely fill up, which may then result in data being lost and/or dropped. As discussed above, such a situation may result in an inefficient use of bandwidth as the lost and/or dropped data would need to be resent, thus using additional bandwidth to resend data that was previously sent.

If the data congestion continues, and the first control message 400 included a control action that instructed the network entity 220 to reduce the rate at which it sends data to the network entity 250 by a certain percentage of its nominal data rate, the amount of data in the source queue 315 in the network entity 250 may continue to increase. In the method 500, at block 530, the network entity 350 may determine that the amount of data queued in the source queue 315 exceed a second threshold. In response to the second threshold being exceeded, the network entity 250 may communicate a second control message 400 to the network entity 220, instructing the network entity 220 to further reduce the rate at which it sends data to the network entity 250 or, alternatively, may instruct the network entity 220 to stop sending data to the network entity 250 for a specific period of time or until a subsequent control message is sent to the network entity 220 instructing it to resume sending data to the network entity 250.

At block 540, the network entity 220, in response to the second control message 400, may further reduce its data rate for sending data to the network entity 250, or may stop sending data to the network entity, as appropriate. In like fashion as discussed above, the network entity 240 may also reduce the rate at which it sends data to the network entity 250 or, alternatively, the network entity 240 may stop sending data to the network entity 250 for a particular period of time or until another control message is sent instructing the network entity 220 to resume sending data to the network entity 250.

As the data congestion in the network 200 is reduced, the amount of data queued in the source queue 315 in the network entity 250 may decrease. Again, the network entity 250 may monitor the amount of queued data in the source queues 315, 320, 325 and 330 (and in certain embodiments, the destination queues 340, 345, 350 and 335). As the amount of data queued in the source queue 315 decreases, it may be determined that the amount of queued data is below a third threshold.

In response to the amount of queued data decreasing below the third threshold, the network entity 250, at block 550, may send a third control message to the network entity 220 instructing the network entity 220 to increase the rate at which it sends data to the network entity 250. In response to the third control message, the network entity 220, at block 555, may resume sending data (in situations where it stopped sending data) to the network entity 250. Depending on the particular control action included in the third control message 400, the network entity 220 may resume sending data to the network entity 250 at a reduced data rate as compared to its nominal data rate or, alternatively, may resume sending data to the network entity 250 at its nominal data rate. Further, at block 555, the network entity 240, in response to the third control message, may resume sending data to the network entity 250 or, alternatively, may increase the rate at which it sends data to the network entity 250 as is appropriate for the particular situation.

The third threshold may be equal to, or less than the second or first threshold. In the situation where the third threshold is below the first or second threshold, there will be some hysterisis between the thresholds. Such an approach may prevent the network entity 250 from repeatedly sending control messages to the network entity 220 if the amount of queued data varies around the first or second threshold, causing one of those thresholds to be repeatedly crossed without any substantial change in the amount of queued data. Such a situation may be an inefficient use of bandwidth, as sending repeated, redundant control messages would consume bandwidth that may be used for data communication to alleviate the data congestion.

FIG. 6 is a flowchart illustrating another example method 600 for communication fabric bandwidth management. As discussed above, the method 600 will be described with reference to the network 100 illustrated in FIG. 1. As also noted above, the method 600 may also be implemented in the network 200 of FIG. 2 or in any number of other appropriate network arrangements. As was further described above, the operation of the network 100 will be described with the network entities 110, 120, 130 and 140 of the ring network each being implemented using the network entity 300 illustrated in FIG. 3.

The method 600, at block 605 may include receiving a first data stream at the network entity 110 in the ring network of the network 100. In this particular embodiment, the first data stream may be addressed for communication to the network entity 120 and may be communicated to the network entity 110 by the service port 150 as add in traffic. Accordingly, the first data stream, at block 610, may be queued in the destination queue 320 of the network entity 110, which is the destination queue associated with the network entity 120.

At block 615, the network entity 110 may receive a second data stream from the network entity 140 (e.g., add-in traffic received from the service port 180). At block 620, the second data stream may be queued in the source queue 330 of the network entity 110, which is the source queue associated with the network entity 140 of the network 100. The second data stream, for this example embodiment, may also be addressed for communication to the network entity 120.

At block 625, the first and second data streams may be communicated from the network entity 110 to the network entity 120 via the schedulers 360 and 335 and the source port 365 of the network entity 110. The first data stream may then be queued in the source queue 315 of the network entity 120 at block 630 and the second data stream may be queued in the source queue 330 of the network entity 120 at block 635.

At block 640, the network entity 120 may determine, for example, as a result of data traffic congestion or other cause, that an amount of queued data in the source queue 330 exceeds a first threshold. At block 645, in response to the first threshold being exceeded, the network entity 120 may communicate a first control message 400 to the network entity 140. In like fashion as described above, the first control message 400 may include a source identifier corresponding with the network entity 140, a destination identifier corresponding with the network entity 120 and a control action instructing the network entity 140 to reduce a data rate at which it communicates the second data stream to the network entity 120.

At block 650, in response to the first control message 400, the network entity 140 may reduce its data rate for the second data stream by a percentage of a nominal data rate or may stop sending the second data stream, depending on the particular control action included in the first control message 400. Also, in similar fashion as discussed above with respect to the method 500 and the network 200, the network entity 110 may also reduce a data rate at which it sends data to the network entity 120.

At block 655, the network entity 110 may receive an EF data stream from the network entity 140. Alternatively, the network entity 110 may receive the EF data stream from the network entity 120. As discussed above, the EF data stream may have a higher communication priority than the first and second data streams. The network entity may then queue the EF data stream in its EF data queue 310.

At block 660, the network entity 120 may, as a result of decreased traffic congestion, determine that the amount of queued data in its source queue 330 is less than a second threshold. As was discussed above with respect to the method 500, the second data threshold at block 660 may be below the first threshold at block 640 in order to have hysterisis between the first and second thresholds, so as to prevent the network entity 120 from communicating repeated, redundant control messages to the network entity 140.

At block 665, in response to the amount of queued data in the source queue 330 of the network entity 120, the network entity 120 may communicate a second control message 400 to the network entity 140, instructing the network entity 140 to increase its data rate for the second data stream. At block 670, in response to the second control message 400, the network entity 400 may increase its data rate for the second data stream, such as in a fashion as described above with respect to block 555 of the method 500.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
receiving data at a first network entity, the data being received from a second network entity;
at the first network entity, queuing the received data in a data queue associated with the second network entity;
determining that an amount of queued data in the data queue associated with the second network entity exceeds a first threshold;
responsive to the first threshold being exceeded, communicating a first control message from the first network entity to the second network entity; and
responsive to the first control message, reducing a data rate at which the second network entity sends data to the first network entity.

2. The method of claim 1, wherein reducing the data rate at which the second network entity sends data to the first network entity comprises one of:
reducing the data rate by a first amount;
reducing the data rate by a second amount; and
stopping sending data from the second network entity to the first network entity.

3. The method of claim 1, further comprising, in response to the first control message, reducing a data rate at which a third network entity communicates data to the first network entity.

4. The method of claim 3, further comprising:
communicating the data from the second network entity to the first network entity via the third network entity; and
communicating the first control message from the first network entity to the second network entity via the third network entity.

5. The method of claim 1, further comprising:
determining that the amount of queued data in the data queue associated with the second network entity exceeds a second threshold, the second threshold being greater than the first threshold;
responsive to the second threshold being exceeded, communicating a second control message from the first network entity to the second network entity; and
responsive to the second control message, further reducing the data rate at which the second network entity sends data to the first network entity.

6. The method of claim 5, wherein further reducing the data rate at which the second network entity sends data to the first network entity comprises stopping sending data from the second network entity to the first network entity.

7. The method of claim 1, further comprising:
determining that the amount of queued data in the data queue associated with the second network entity is below a second threshold;
responsive to the amount of received data being below the second threshold, communicating a second control message from the first network entity to the second network entity; and
responsive to the second control message, increasing the data rate at which the second network entity sends data to the first network entity.

8. The method of claim 7, further comprising:
in response to the first control message, reducing a data rate at which a third network entity communicates data to the first network entity; and
in response to the second control message, increasing the data rate at which a third network entity communicates data to the first network entity.

9. The method of claim 7, wherein the second threshold is less than the first threshold.

10. The method of claim 7, wherein increasing the data rate at which the second network entity sends data to the first network entity comprises one of:
resuming communication of data from the second network entity to the first network entity at a reduced data rate relative to a nominal data rate;
resuming communication of data from the second network entity to the first network entity at the nominal data rate; and
increasing the data rate from the reduced data rate to the nominal data rate.

11. The method of claim 1, wherein the second network entity sends data to the first network entity in accordance with a work-conserving, fair-scheduling procedure.

12. The method of claim 1, wherein the queued data is communicated to a third network entity in accordance with a work-conserving, fair-scheduling procedure.

13. A method comprising:
receiving a first data stream at a first network entity, the first data stream being:
communicated to the first network entity by a second network entity; and
adapted to be communicated to a third network entity;
queuing the first data stream in a first data queue, the first data queue being:
associated with the third network entity; and
included in a first plurality of data queues in the first network entity;
receiving a second data stream at the first network entity, the second data stream being:
communicated to the first network entity by a fourth network entity; and
adapted to be communicated to the third network entity;
queuing the second data stream in a second data queue, the second data queue being:
associated with the fourth network entity; and
included in a second plurality of data queues in the first network entity;
communicating the first and second data streams from the first network entity to the third network entity;
queuing the first data stream in a third data queue, the third data queue being:
associated with the first network entity; and
included in a first plurality of data queues in the third network entity;
queuing the second data stream in a fourth data queue, the fourth data queue being:
associated with the fourth network entity; and
included in the first plurality of data queues in the third network entity;
determining that an amount of queued data in the fourth data queue exceeds a first threshold;
responsive to the first threshold being exceeded, communicating a first control message from the third network entity to the fourth network entity; and
responsive to the first control message, reducing a data rate at which the fourth network entity sends data to the third network entity.

14. The method of claim 13, further comprising:
communicating the first control message from the third network entity to the fourth network entity via the first network entity; and
responsive to the first control message, reducing a data rate at which the first network entity communicates the first data stream to the third network entity.

15. The method of claim 13, further comprising receiving a third data stream at the first network entity, the third data stream being:
communicated from a fifth data queue in the fourth network entity to a sixth data queue in the first network entity; and
an expedited forwarding data stream having a higher transmission priority than the first and second data streams.

16. The method of claim 13, wherein the first control message has a higher transmission priority than the first and second data streams.

17. The method of claim 13, further comprising:
determining that the amount of queued data in the fourth data queue is below a second threshold, the second threshold being less than the first threshold;
responsive to the amount of received data being below the second threshold, communicating a second control message from the third network entity to the fourth network entity; and
responsive to the second control message, increasing the data rate at which the fourth network entity sends the second data stream to the third network entity.

18. A computer program product, tangibly-embodied on a machine-readable storage medium, storing instructions that, when executed, cause a machine to provide for:
receiving a first data stream at a first network entity, the first data stream being:
communicated to the first network entity by a second network entity; and
adapted to be communicated to a third network entity;
queuing the first data stream in a first data queue, the first data queue being:
associated with the third network entity; and
included in a first plurality of data queues in the first network entity;
receiving a second data stream at the first network entity, the second data stream being:
communicated to the first network entity by a fourth network entity; and
adapted to be communicated to the third network entity;
queuing the second data stream in a second data queue, the second data queue being:
associated with the fourth network entity; and
included in a second plurality of data queues in the first network entity;
communicating the first and second data streams from the first network entity to the third network entity;
queuing the first data stream in a third data queue, the third data queue being:
associated with the first network entity; and
included in a first plurality of data queues in the third network entity;
queuing the second data stream in a fourth data queue, the fourth data queue being:
associated with the fourth network entity; and
included in the first plurality of data queues in the second network entity;
determining that an amount of queued data in the fourth data queue exceeds a first threshold;
responsive to the first threshold being exceeded, communicating a first control message from the second network entity to the fourth network entity; and
responsive to the first control message, reducing a data rate at which the fourth network entity sends data to the second network entity.

19. The computer product of claim 18, wherein:
the first, third and fourth network entities are included in a ring network; and
the second network entity comprises a service port adapted to add data traffic to the ring network.

20. The computer product of claim 18, wherein:
the first, third and fourth network entities are included in a mesh network; and
the second network entity is a network entity operatively coupled with the mesh network that is adapted to add data traffic to the mesh network.
